(19) United States
(12) Patent Application Publication
(10) Pub. No.: US 2015/0350822 A1
(43) Pub. Date: Dec. 3, 2015

(54) Electronic Devices with Motion Characterization Circuitry

(71) Applicant: Apple Inc., Cupertino, CA (US)

(72) Inventors: Xiao Xiao, Orinda, CA (US); Hung A. Pham, Oakland, CA (US); Sunny K. Chow, San Jose, CA (US)

(21) Appl. No.: 14/501,725

(22) Filed: Sep. 30, 2014

Related U.S. Application Data
(60) Provisional application No. 62/004,707, filed on May 29, 2014.

(51) Int. Cl. H04W 4/02; H04W 64/00

(52) U.S. Cl. CPC H04W 4/02; H04W 64/006

(57) ABSTRACT

An electronic device may include a motion sensor for detecting movement of the electronic device. Applications that run on the electronic device such as fitness applications or activity logging applications may use motion sensor data to track a user's physical activity. To avoid mischaracterizing a user's movement, motion sensor circuitry in the electronic device may supplement motion sensor data with additional information in instances where motion sensor data alone may be insufficient to distinguish between different types of physical activity. For example, information on a user's speed may be synthesized with motion sensor data to help characterize a user's movement. Information on a user's speed may be determined based on location information. The location information may, for example, be gathered using IEEE 802.11 transceiver circuitry or, in more rural areas, may be gathered using Global Positioning System receiver circuitry.

This application claims the benefit of provisional patent application No. 62/004,707, filed May 29, 2014, which is hereby incorporated by reference herein in its entirety.

### BACKGROUND

This relates generally to electronic devices and, more particularly, to electronic devices with motion sensor circuitry for detecting and characterizing a user's movement.

Electronic devices are sometimes provided with motion sensors such as accelerometers that are configured to detect a user's movement. Applications that run on an electronic device may use motion sensor information to track a user's physical activity. For example, a fitness application running on an electronic device may use motion sensor data to log or record how long or far a user runs, walks, cycles, or performs other activities.

Conventional electronic devices determine what type of physical activity is being performed (e.g., walking, cycling, running, etc.) based solely on the output from an accelerometer. Relying exclusively on accelerometer signals to determine what type of activity is being performed by a user can lead to inaccuracies. For example, accelerometer signals that are collected while a user is walking may sometimes look similar to accelerometer signals that are collected while a user is cycling.

It would therefore be desirable to be able to provide improved ways of using an electronic device to characterize the movement of a user.

### SUMMARY

An electronic device may include a motion sensor such as one or more accelerometers, gyroscopes, and/or compasses for detecting movement of the electronic device. Applications that run on the electronic device such as fitness applications or activity logging applications may use motion sensor data to track a user's physical activity.

To avoid mischaracterizing a user's movement, motion sensor circuitry in the electronic device may supplement motion sensor data with additional information in instances where motion sensor data may be insufficient to distinguish between different types of physical activity.

For example, information on a user's speed may be synthesized with motion sensor data to help characterize a user's movement. Information on a user's speed may be determined based on location information. The location information may, for example, be gathered using IEEE 802.11 (WiFi®) transceiver circuitry or, in more rural areas, may be gathered using Global Positioning System circuitry.

In WiFi®-assisted positioning, wireless transceiver circuitry in the electronic device may gather information on local wireless access points in a vicinity of the electronic device. This information may be transmitted to a server, which may respond with a set of geographic coordinates indicating where the electronic device is geographically located. This geographic location information may be used to estimate a user's average speed as he or she travels from one location to another. The user's average speed may be used in combination with motion sensor data to determine what activity is being performed by the user (e.g., running, walking, cycling, etc.).

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device of the type that may be provided with motion sensor circuitry in accordance with an embodiment of the present invention.

FIG. 2 is a schematic diagram of an illustrative electronic device having motion sensor circuitry in accordance with an embodiment of the present invention.

FIG. 3 is a front view of an illustrative electronic device in which motion sensor information is being used to track and display a user's physical activity on a map in accordance with an embodiment of the present invention.

FIG. 4 is a front view of an illustrative electronic device in which motion sensor information is being used to enter and display a user's physical activity in an activity log in accordance with an embodiment of the present invention.

FIG. 5 is a diagram showing how information about user's speed may be used to assist in activity characterization when motion sensor data alone is insufficient to discriminate between different activities in accordance with an embodiment of the present invention.

FIG. 6 is a diagram illustrating how information about local wireless access points can be used to help characterize the type of activity being performed by a user in accordance with an embodiment of the present invention.

FIG. 7 is a flow chart of illustrative steps involved in tracking and characterizing a user's physical activity using an electronic device in accordance with an embodiment of the present invention.

### DETAILED DESCRIPTION

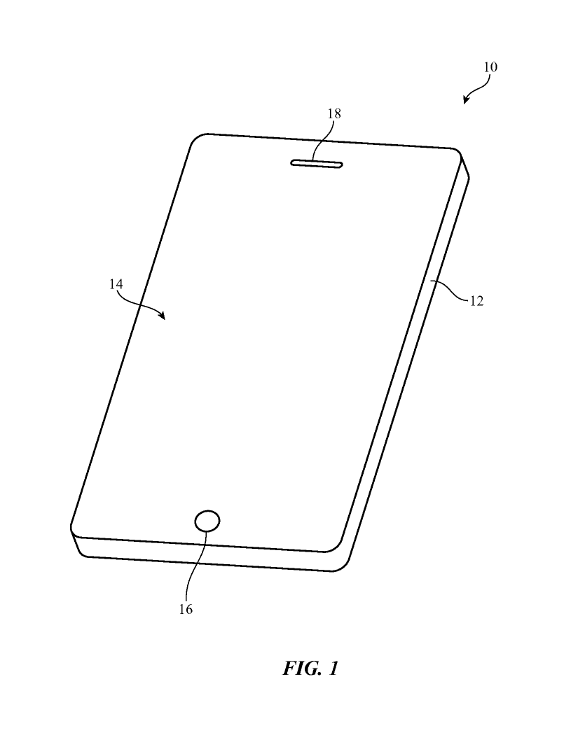

An illustrative electronic device that may be provided with motion characterization circuitry is shown in FIG. 1. Electronic device 10 of FIG. 1 may be a handheld electronic device or other electronic device. For example, electronic device 10 may be a cellular telephone, media player, or other handheld portable device, a somewhat smaller portable device such as a wrist-watch device, pendant device, or other wearable or miniature device, gaming equipment, a tablet computer, a notebook computer, a desktop computer, a television, a computer monitor, a computer integrated into a computer display, or other electronic equipment.

In the example of FIG. 1, device 10 includes a display such as display 14. Display 14 has been mounted in a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies. The brightness of display 14 may be adjustable. For example, display 14 may include a backlight unit formed from a light source such as a lamp or light-emitting diodes that can be used to increase or decrease display backlight levels and thereby adjust display brightness. Display 14 may also include organic light-emitting diode pixels or other pixels with adjustable intensities. In this type of display, display brightness can be adjusted by adjusting the intensities of drive signals used to control individual display pixels.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as speaker port 18.

In the center of display 14, display 14 may contain an array of active display pixels. This region is sometimes referred to as the active area of the display. A rectangular ring-shaped region surrounding the periphery of the active display region may not contain any active display pixels and may therefore sometimes be referred to as the inactive area of the display. The display cover layer or other display layers in display 14 may be provided with an opaque masking layer in the inactive region to hide internal components from view by a user.

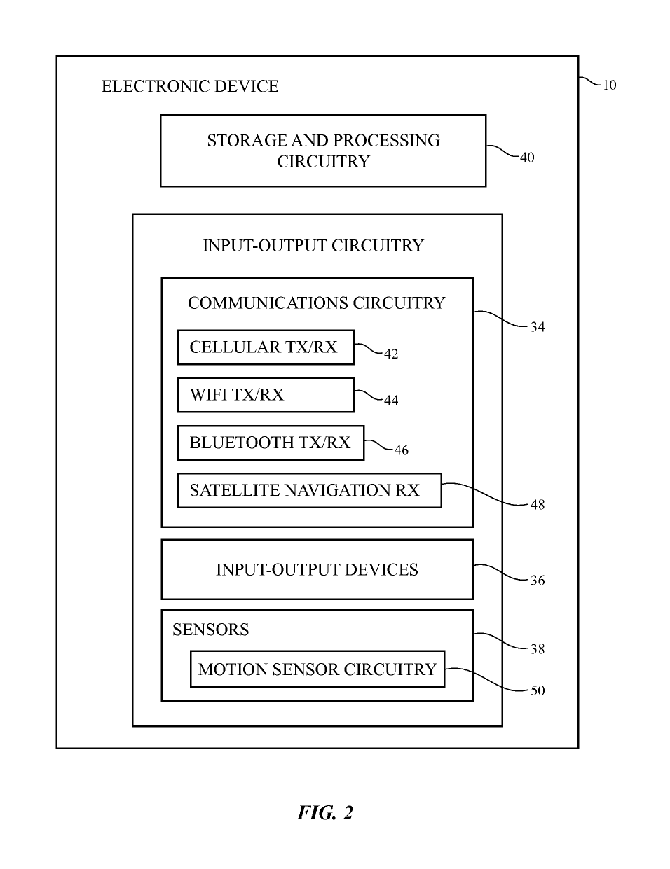

A schematic diagram of device 10 is shown in FIG. 2. As shown in FIG. 2, electronic device 10 may include control circuitry such as storage and processing circuitry 40. Storage and processing circuitry 40 may include one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 40 may be used in controlling the operation of device 10. The processing circuitry may be based on one or more microprocessors, microcontrollers, digital signal processors, baseband processor integrated circuits, application specific integrated circuits, etc.

With one suitable arrangement, storage and processing circuitry 40 may be used to run software on device 10 such as internet browsing applications, email applications, media playback applications, activity logging applications, fitness applications, operating system functions, software for capturing and processing images, software implementing functions associated with gathering and processing sensor data, software that makes adjustments to display brightness and touch sensor functionality, etc.

To support interactions with external equipment, storage and processing circuitry 40 may be used in implementing communications protocols. Communications protocols that may be implemented using storage and processing circuitry 40 include internet protocols, wireless local area network protocols (e.g., IEEE 802.11 protocols—sometimes referred to as WiFi®), protocols for other short-range wireless communications links such as the Bluetooth® protocol, etc.

Input-output circuitry 32 may be used to allow input to be supplied to device 10 from a user or external devices and to allow output to be provided from device 10 to the user or external devices.

Input-output circuitry 32 may include wired and wireless communications circuitry 34. Communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). As shown in FIG. 2, circuitry 34 may include one or more radio-frequency transceivers such as cellular telephone transceiver circuitry 42 (e.g., one or more cellular telephone transmitters and/or receivers), IEEE 802.11 (WiFi®) transceiver circuitry 44 (e.g., one or more wireless local area network transmitters and/or receivers), Bluetooth® transceiver circuitry 46 such as a Bluetooth® Low Energy (Bluetooth LE) transmitter and/or receiver, and satellite navigation system receiver circuitry (e.g., a Global Positioning System receiver or other satellite navigation system receiver).

Input-output circuitry 32 may include input-output devices 36 such as buttons, joysticks, click wheels, scrolling wheels, touch screens, other components with touch sensors such as track pads or touch-sensor-based buttons, vibrators, audio components such as microphones and speakers, image capture devices such as a camera module having an image sensor and a corresponding lens system, keyboards, status-indicator lights, tone generators, key pads, keyboards and other equipment for gathering input from a user or other external source and/or generating output for a user.

Sensor circuitry such as sensors 38 of FIG. 2 may include an ambient light sensor for gathering information on ambient light levels, proximity sensor components (e.g., light-based proximity sensors and/or proximity sensors based on other structures), accelerometers, gyroscopes, magnetic sensors, and other sensor structures. Sensors 38 of FIG. 2 may, for example, include one or more microelectromechanical systems (MEMS) sensors (e.g., accelerometers, gyroscopes, microphones, force sensors, pressure sensors, capacitive sensors, or any other suitable type of sensor formed using microelectromechanical systems technology). If desired, other components in device 10 may be formed using microelectromechanical systems technology.

Sensors 38 may include motion sensor circuitry 50 (sometimes referred to as motion characterization circuitry). Motion sensor circuitry 50 may include one or more motion sensors for detecting movement of device 10. Motion sensors that may be used in motion sensor circuitry 50 include accelerometers (e.g., accelerometers that measure acceleration along one, two, or three axes), gyroscopes, compasses, pressure sensors, other suitable types of motion sensors, etc. Motion sensor circuitry 50 may use storage and processing circuitry (e.g., storage and processing circuitry 40) to store and process motion sensor data gathered using motion sensor circuitry 50. If desired, the motion sensors, processing circuitry, and storage that form motion sensor circuitry 50 may form part of a system-on-chip integrated circuit (as an example).

Motion sensor circuitry 50 may be used to continuously or periodically track movement of device 10. In cases where device 10 is handheld, wearable, or otherwise portable, movement of device 10 may be indicative of the movement of a user of device 10. For example, when a user is holding, wearing, or otherwise carrying device 10 on his or her person, motion sensor circuitry 50 may be used to track the user's movement based on sensor data gathered from one or more motion sensors in motion sensor circuitry 50.

User movement information gathered by motion sensor circuitry 50 may be used in various ways. For example, applications that run on device 10 such as fitness applications, activity logging applications, mapping applications, journaling applications, and other applications may use motion sensor circuitry 50 to track, log, and/or record a user's physical activity.

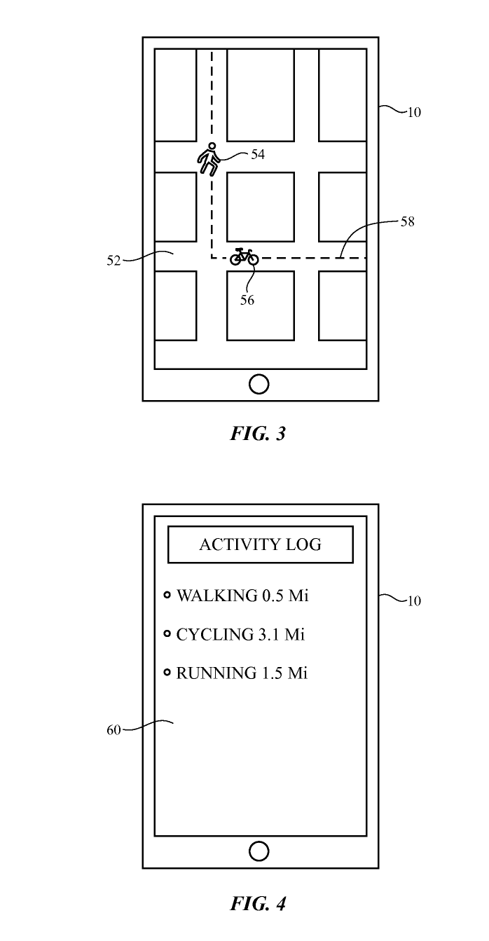

In many of these applications, motion sensor circuitry 50 may be used not only to detect a user's movement but to determine what type of activity is being performed based on the detected motion. For example, as shown in FIG. 3, application 52 running on electronic device 10 may track and display a user's route 58 on a map. Using motion sensor circuitry 50, application 52 may indicate which portions of the route were walked by the user (e.g., as indicated by icon 54) and which portions of the route were cycled by a user (e.g., as indicated by icon 56). In the example of FIG. 4, application 60 running on device 10 may display an activity log where the user can view a list physical activities performed.

The examples of FIGS. 3 and 4 are merely illustrative. In general, any suitable application may rely on motion sensor circuitry 50 to track a user's motion and to determine what type of activity is being performed by the user (e.g., walking, running, cycling, skiing, riding in a car, roller skating, etc.). If desired, user interface elements may be adjusted or controlled based on user activity information or applications may be launched on device 10 based on user activity information.

Motion sensor circuitry 50 may determine which type of activity is being performed based at least partly on motion sensor data (e.g., from an accelerometer or other motion sensor). For example, motion sensor circuitry 50 may determine a user's cadence based on motion sensor output. Based on the user's cadence, motion sensor circuitry 50 may determine which type of activity is being performed by the user. For example, motion sensor circuitry may determine that cadences below a given threshold correspond to walking, whereas cadences above the given threshold correspond to running.

Conventional electronic devices classify motion based solely on accelerometer output. Relying exclusively on accelerometer output to determine what type of activity is being performed can lead to inaccuracies. For example, accelerometer signals that are collected while a user is walking may look similar to accelerometer signals that are collected when a user is cycling. As another example, accelerometer signals that are collected when a user is cycling may look similar to accelerometer signals that are collected while a user is riding in a car experiencing low vibrations.

To avoid misclassification of a user's activity, motion sensor circuitry 50 may use additional information to further characterize a user's movement when needed. For example, motion sensor circuitry 50 may gather additional information such as information about a user's speed and may synthesize this information with motion sensor output to determine what type of activity is being performed by the user.

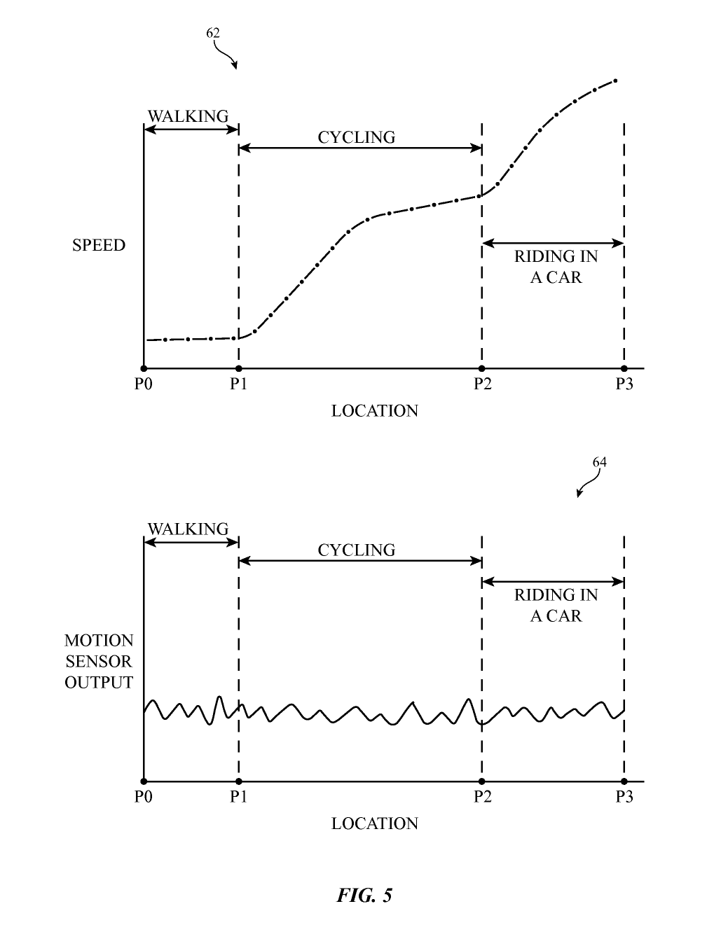

FIG. 5 is a diagram showing how a user's speed may be useful in characterizing a user's activity when motion sensor output alone may be insufficient. Graph 62 of FIG. 5 illustrates how a user's speed may change as the user walks from location P0 to location P1, cycles from location P1 to location P2, and rides in a car from location P2 to location P3. Graph 64 illustrates how a motion sensor might record the same route. If, for example, a user walks at 120 paces per minute (corresponding to a cadence of 60 revolutions per minute) and cycles at 50 revolutions per minute, it may be difficult to distinguish the walking from the cycling using the motion sensor output alone. As shown in graph 64, there may also be instances where a user is riding in a car and is experiencing vibrations that produce an accelerometer output not dissimilar from that produced when the user is cycling.

In these instances, motion sensor circuitry 50 may determine a user's speed or relative speed and may use this information to supplement motion sensor data to identify what type of activity is being performed. As shown in graph 62, a user's speed may differ significantly as the type of activity changes.

A user's speed may be determined in various ways. For example, a user's speed may be determined using Global Position System (GPS) circuitry such as satellite navigation receiver circuitry 48 of FIG. 2. By determining how the location of device 10 changes over time, an approximate (average) speed may be determined. Motion sensor circuitry 50 may synthesize this information with motion sensor output to determine what type of activity is being performed by the user. For example, for a given cadence detected by the motion sensor, speeds over a given threshold may correspond to cycling while speeds under the given threshold may correspond to walking.

If desired, a user's approximate speed may be determined without using GPS circuitry. For example, circuitry in device 10 may be configured to determine the geographic location of device 10 using information about nearby wireless access points (e.g., local WiFi® hotspots). This location information may in turn be used to determine an approximate distance traveled over a given period of time. Motion sensor circuitry 50 may synthesize this information with motion sensor output to determine what type of activity is being performed by the user. For example, for a given cadence detected by the motion sensor, speeds over a given threshold may correspond to one activity (e.g., cycling) while speeds under the given threshold may correspond to a different activity (e.g., walking).

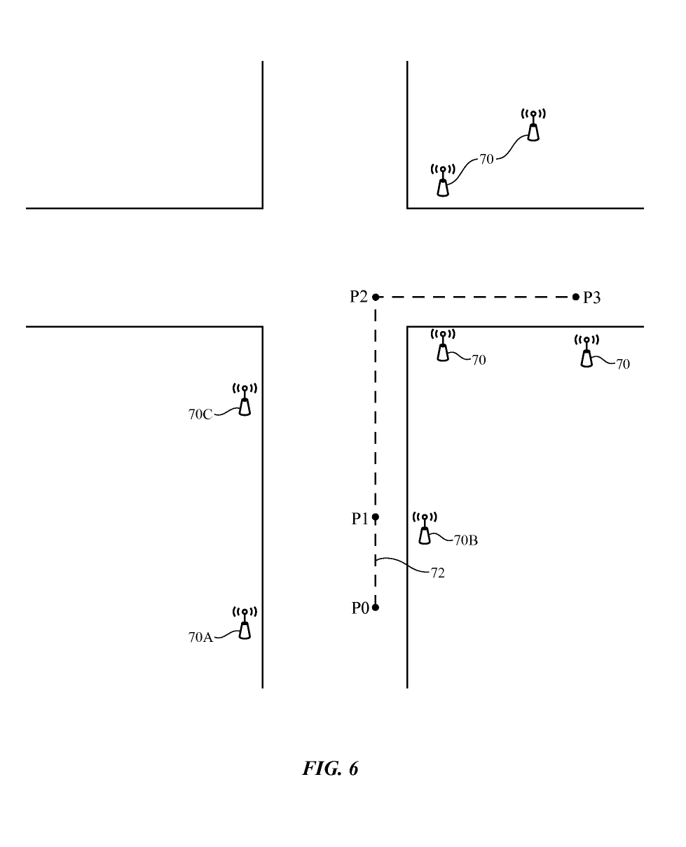

FIG. 6 is a diagram illustrating how information about local wireless access points can be used to help classify the type of activity being performed by a user of electronic device 10. As shown in FIG. 6, a user may pass a collection of wireless access points 70 (e.g., WiFi® hotspots) as he or she travels from location P0 to location P1 to location P2 to location P3. In this example (as with the example of FIG. 5), the user may walk from location P0 to location P1, cycle from location P1 to location P2, and ride in a car from location P2 to location P3.

Electronic device 10 may use wireless communications circuitry (e.g., wireless transceiver circuitry 44 of FIG. 2) to take a snapshot of wireless access points 70 within a communication range of electronic device 10. Electronic device 10 may send this snapshot of local wireless hotspots to a server, which may respond with a set of approximate geographic coordinates indicating where device 10 is located. The geographic coordinates may be determined using any suitable method (e.g., triangulation methods, time-of-flight methods, using a crowdsourced location database, etc.).

In the example of FIG. 6, electronic device 10 at position P0 may be within communication range of access points 70A and 70B, whereas electronic device 10 at position P1 may be within communication range of access points 70A, 70B, and 70C. This information may be used to determine an approximate location of electronic device 10 at P0 and P1. Electronic device 10 (e.g., processing circuitry 40 that forms part of motion sensor circuitry 50 or processing circuitry 40 that is separate from motion sensor circuitry 50) may use this location information to determine the distance between location P0 and location P1. Based on the amount of time taken to travel this distance, an average speed may be determined. Motion sensor circuitry 50 may use this information along with motion sensor output (e.g., motion sensor output of the type shown in FIG. 5) to characterize the user's motion along path 72. In this example, motion sensor circuitry 50 may determine that, based on the user's average speed (as detected through WiFi®-assisted positioning) and the user's cadence (as detected by a motion sensor), the user is walking rather than cycling along path 72.

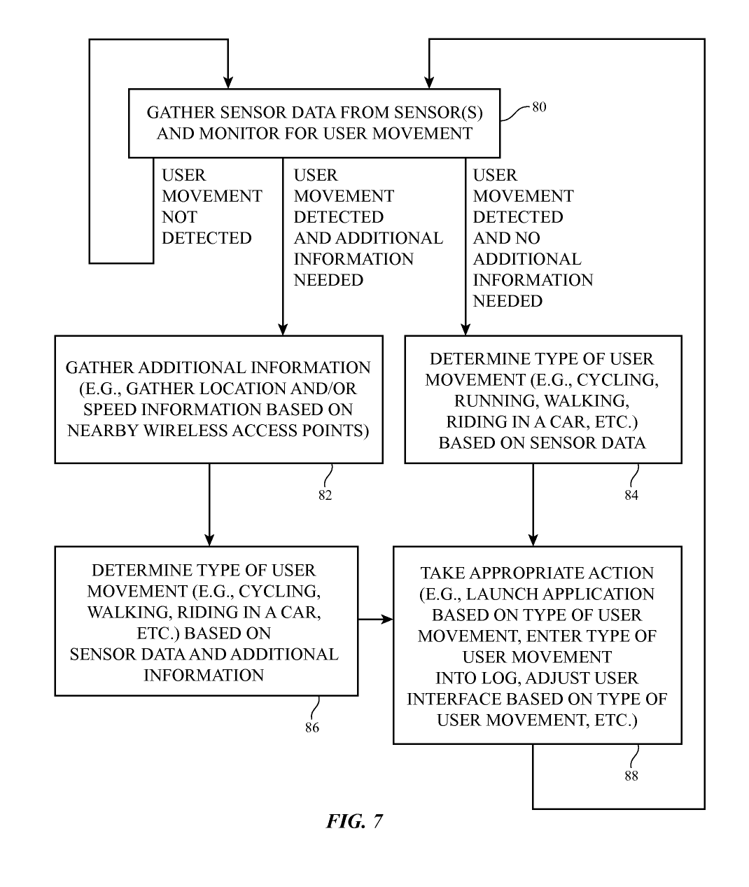

FIG. 7 is a flow chart of illustrative steps involved in tracking and characterizing a user's physical activity using an electronic device such as electronic device 10 of FIGS. 1 and 2.

At step 80, motion sensor circuitry 50 may gather sensor data from one or more motion sensors (e.g., from one or more accelerometers, gyroscopes, compasses, pressure sensors, etc.) and may monitor for user movement. In configurations where motion sensor circuitry is set to continuously track a user's activity (e.g., for a fitness application running on device 10 or other suitable application), step 80 may be repeated until the user's movement is detected.

In some instances, motion sensor output may be unambiguously indicative of a particular type of activity. For example, motion sensor signals collected while a user is running may be uniquely associated with running. As another example, motion sensor signals collected while a user is cycling at 100 RPM may be uniquely associated with cycling. When motion sensor signals are indicative of only one particular type of activity, processing may proceed to step 84.

At step 84, motion sensor circuitry 50 may determine what type of activity is being performed by the user (e.g., running, cycling, walking, riding in a car, etc.) based on the gathered motion sensor data.

In instances where motion sensor data gathered in step 80 is not uniquely associated with a particular type of user activity (e.g., where motion sensor signals are associated with more than one type of activity), processing may proceed from step 80 to step 82.

At step 82, motion sensor circuitry 50 may gather additional information such as information about the user's location and speed to assist in accurately identifying the type of activity associated with the gathered motion sensor data. For example, wireless transceiver circuitry 44 may be used to take one or more snapshots of local wireless access points within a vicinity of electronic device 10. This information may be used to determine the approximate location of device 10 and how the user's location changes over time. In locations where local wireless access points are few and far between (e.g., in rural areas), motion sensor circuitry 50 may gather location information from other sources such as Global Positioning System receiver circuitry 48.

By supplementing motion sensor data with additional information (e.g., location information) only when motion sensor data alone is insufficient for classifying motion, power savings may be achieved. Additional power savings may be achieved by relying on Global Positioning System receiver circuitry to obtain location information only when local wireless access points are not available.

At step 86, motion sensor circuitry 50 may associate the gathered motion sensor data with a single type of activity using the additional information gathered in step 82 (e.g., based on the user's average speed as determined through WiFi®-assisted positioning). For example, for a given cadence detected by the motion sensor, speeds over a given threshold may correspond to one activity (e.g., cycling) while speeds under the given threshold may correspond to a different activity (e.g., walking).

At step 88, device 10 may take appropriate action. For example, processing circuitry 40 may launch an application on device 10 based on the type of activity detected (e.g., a cycling application may be launched upon detection of a user cycling), the user's activity may be recorded or entered into an activity journaling application, user interface elements bay be adjusted or controlled based on the type of activity detected, etc. Processing may then optionally loop back to step 80 to continue tracking and/or monitoring for user activity.

The foregoing is merely illustrative of the principles of this invention and various modifications can be made by those skilled in the art without departing from the scope and spirit of the invention.

What is claimed is:

1. A portable electronic device, comprising:
a motion sensor that gathers motion sensor data indicative of a user's movement;
wireless communications circuitry that gathers location information indicative of the user's location; and
processing circuitry that characterizes the user's movement based on the motion sensor data and the location information.

2. The portable electronic device defined in claim 1 wherein the motion sensor comprises an accelerometer.

3. The portable electronic device defined in claim 1 wherein the wireless communications circuitry comprises IEEE 802.11 transceiver circuitry.

4. The portable electronic device defined in claim 3 wherein the wireless communications circuitry gathers information about local wireless access points in a vicinity of the portable electronic device and wherein the location information is based on the information about the local wireless access points.

5. The portable electronic device defined in claim 4 wherein the processing circuitry determines an average speed of the user based on the location information.

6. The portable electronic device defined in claim 5 wherein the processing circuitry characterizes the user's movement based on the average speed and the motion sensor data.

7. A method for operating an electronic device having a motion sensor, wireless communications circuitry, and processing circuitry, the method comprising:
with the motion sensor, gathering motion sensor data indicative of a user's movement;
with the wireless communications circuitry, gathering location information indicative of the user's location; and
with the processing circuitry, characterizing the user's movement based on the motion sensor data and the location information.

8. The method defined in claim 7 wherein characterizing the user's movement comprises determining that the user's movement corresponds to an activity selected from the group consisting of: walking and cycling.

9. The method defined in claim 7 wherein gathering the location information comprises gathering information on local wireless access points in a vicinity of the electronic device.

10. The method defined in claim 9 further comprising:
transmitting the information on the local wireless access points to a server; and
receiving geographic coordinates from the server.

11. The method defined in claim 9 further comprising:
with the processing circuitry, determining an average speed of the user based on the location information.

12. The method defined in claim 11 wherein characterizing the user's movement comprises:
associating the motion sensor data with at least first and second activities; and
based on the average speed of the user, characterizing the user's movement as one of the first and second activities.

13. The method defined in claim 7 further comprising:
with the motion sensor, gathering additional motion sensor data indicative of the user's movement; and
without using the location information, characterizing the user's movement based on the additional motion sensor data.

14. The method defined in claim 13 wherein characterizing the user's movement based on the additional motion sensor data comprises determining that the user's movement corresponds to running.

15. A method for operating an electronic device having a motion sensor and processing circuitry, the method comprising:
with the motion sensor, gathering motion sensor data indicative of a user's movement;
with the processing circuitry, gathering information on the user's speed; and
characterizing the user's movement based on the motion sensor data and the information on the user's speed.

16. The method defined in claim 15 wherein gathering information on the user's speed comprises gathering geographic location information using IEEE 802.11 transceiver circuitry.

17. The method defined in claim 16 wherein gathering the geographic location information comprises gathering information on local wireless access points in a vicinity of the electronic device.

18. The method defined in claim 17 wherein gathering the geographic location information comprises:
transmitting the information on the local wireless access points to a server; and
receiving geographic coordinates from the server.

19. The method defined in claim 15 wherein gathering information on the user's speed comprises gathering geographic location information using global positioning system receiver circuitry.

20. The method defined in claim 15 wherein characterizing the user's movement comprises determining that the user's movement corresponds to an activity selected from the group consisting of: walking, cycling, and running.
